(19) United States
(12) Patent Application Publication
(10) Pub. No.: US 2010/0021236 A1
(43) Pub. Date: Jan. 28, 2010

(54) Water Retention/Detention Structure

(76) Inventor: John E. Kreikemeier, Alpharetta, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/505,233

(22) Filed: Jul. 17, 2009

Related U.S. Application Data
(60) Provisional application No. 61/081,460, filed on Jul. 17, 2008.

(51) Int. Cl. B65G 5/00

(52) U.S. Cl. 405/55

(57) ABSTRACT

A simple, modular, straight forward approach to the assembly of a water retention/detention structure or system to retain or detain, for example, storm water runoff and/or grey water is provided. In one embodiment, the system can include six or more panels of the present disclosure arranged adjacent to each other to form an assembly, the assembly having a hollow interior and in which each panel has an opposite panel across the hollow interior. Panels are provided for the assembly that have a first surface, for example a planar surface, four sides of which define outer edges of each panel, one or more tabs extending laterally from each of the outer edges of each panel in substantially identical spacing on each of the sides of each panel, and one or more recesses formed in substantially identical spacing on each of the sides of each panel, the one or more recesses corresponding in location along the sides of the panels to the one or more tabs. The one or more tabs of one outer edge of a first one of the panels are designed to communicate with the one or more recesses of one outer edge of a second one of the panels for assembly of the panels to form the water retention/detention structure or system.

### CROSS-REFERENCE TO RELATED APPLICATION

This application claims the benefit of and priority to U.S. Provisional Patent Application No. 61/081,460, filed Dec. Jul. 17, 2008 entitled “Water Retention/Detention Structure Formed from Identical Panels” which is incorporated by reference in its entirety as if fully set forth herein.

### BACKGROUND

Improperly managed storm water runoff flows from impervious surfaces picking up pollutants and washes them into rivers and streams. Storm water runoff causes flooding and erosion, destroys habitat, and contributes to storm sewer overflows. Storm water retention and detention basins can be constructed underground with reclaimed water released slowly into rivers and streams or retained on site for irrigation purposes. Pretreatment structures can provide for the removal of debris and pollutants prior to entering the retention/detention structures. Underground retention structures can also be used for the storage of grey water, providing for sustainable subsurface irrigation. These underground structures can be used to free up valuable space on site for parking lots, play grounds, parks, gardens and other amenities.

Current retention/detention systems include an array of heavy and cumbersome concrete structures that are extremely expensive to transport and install. Other structures consist of a multitude of small molded plastic parts that are labor intensive and often present confusion when assembling due to the large number of different parts in the system. These systems have little or no access to the structure for maintenance. Other systems consist of an assemblage of large pipes or arched structures that require large quantities of expensive gravel in their installation and have very limited access for maintenance.

### SUMMARY

The object of the present disclosure is to provide a simple, modular, straight forward approach to the assembly of a water retention/detention structure to retain or detain, for example, storm water runoff and/or grey water. In one embodiment, the structure can be an underground facility. The structure can consist of lightweight, structural, panels that when assembled provide a sturdy framework for the structure. In one embodiment, the panels can be substantially square panels, though other shapes, such as a rectangular shape may be used. In one embodiment the simplicity of this disclosure provides for a unique panel where six identical panels can be assembled to form a perfect hollow cube. Likewise, ten panels can be assembled to form a connected double cube and 14 like panels can be assembled to form a connected triple cube and the like. Simplicity of design prevails as confusion over multiple parts and their assembly is eliminated. The panels are relatively light weight, compact and can be palletized to facilitate easy and inexpensive transportation.

In one embodiment, one or more water retention/detention structures of the present disclosure can be placed in an excavation that has been graded, leveled and compacted. A geotextile material or fabric can be placed on the leveled surface within the excavation. A geogrid can then be placed over the geotextile to provide a sound base for the assembled structure. A thin layer of gravel is at times placed between the geotextile and the geogrid to facilitate laser leveling and compaction, but is optional. Single, double, or triple cubes or other shaped structures of the present disclosure can then be placed vertically or horizontally on the base depending on the specified or desired height of the storage structure. Multiple cubes or assembled structures can be placed adjacent to each other in length and width to form a composite water retention/detention facility of the present disclosure. The desired height, length, and width of the water retention/detention structure can determine the overall size and construction of a storm water storage facility of the present disclosure. Special insert accessories for the structure can be provided for infill pipes, overflow pipes, filtration devices, access panels, drain grates and the like.

After the placement of the specified number of cubes or assembled structures, the exterior of the facility may be covered with a geogrid, followed by the installation of a geotextile such covering, however, being optional. This assembly can prevent soil intrusion into water retention/detention facility of the present disclosure and can allow for water to be absorbed into the surrounding soil. Water can also permeate into the underlying soil. The top of the storage facility can receive a like covering of geotextile over a geogrid prior to soil backfill and compaction. A top soil covering can provide a base for parking lots, playgrounds, tennis courts, athletic fields and the like.

Thus, in one embodiment, a system for retaining or detaining water or both is provided. The system can include six or more panels of the present disclosure arranged adjacent to each other to form an assembly, the assembly having a hollow interior and in which each panel has an opposite panel across the hollow interior. Panels are provided for the assembly that have a first surface, for example a planar surface, four sides of which define outer edges of each panel, one or more tabs extending laterally from each of the outer edges of each panel in substantially identical spacing on each of the sides of each panel, and one or more recesses formed in substantially identical spacing on each of the sides of each panel, the one or more recesses corresponding in location along the sides of the panels to the one or more tabs. The one or more tabs of one outer edge of a first one of the panels are designed to communicate with the one or more recesses of one outer edge of a second one of the panels for assembly of the panels.

In one embodiment at least two tabs extend laterally from each of the outer edges of each panel, the tabs being spaced apart from each other along the outer edges forming a recess between the tabs. In another embodiment, the panels have substantially identical configurations along their peripheral sides and the peripheral sides of each of the panels can be a substantially similar length wherein said panels are substantially identical.

The panels can be designed to include a first surface and ribs extending from the first surface of one or more of the panels to provide strength or reinforcement to the panels, and/or an aperture in a first surface of said panel defining a hole therein for receiving a reinforcing member positioned between opposed panels within the hollow interior of an assembly. In a particular embodiment one or more of the panels can have a peripheral truss structure or has ribs on one of its planar surfaces or both. The peripheral truss structure can have an opening formed through the panel interior of the truss structure wherein the peripheral truss structure is designed to receive an insert within the interior opening.

In a further embodiment of the present disclosure the system can be formed of six or more panels as described herein arranged adjacent each other to form a first assembly, six or more additional panels arranged adjacent to each other to form a second assembly, and the first assembly and second assembly positioned together to form a composite assembly comprised of both the first assembly and the second assembly. More than two such assemblies can be incorporated into the composite assembly, if desired. The composite assembly can include at least one panel having a peripheral truss structure and a central opening for receiving an insert. The insert can be selected from one or more of, for example, an access structure, a drainage inlet, and/or a discharge outlet.

In a further embodiment a structure or device for storm water or grey water retention is provided including a system or assembly of the panels described herein, a liner into which the system or assembly can be placed and a top for covering the liner and assembly. The liner and the top can comprise a preformed structure, and the liner and the top can be formed of a water impermeable material.

Other systems, devices, features, and advantages of the disclosed water retention/detention system and assembly will be or will become apparent to one with skill in the art upon examination of the following drawings and detailed description. All such additional systems, assemblies, devices, features, and advantages are intended to be included within this description, are intended to be included within the scope of the present invention, and are intended to be protected by the accompanying claims.

### BRIEF DESCRIPTION OF THE DRAWINGS

Many aspects of the present disclosure can be better understood with reference to the following figures. The components in the drawings are not necessarily to scale, emphasis instead being placed upon clearly illustrating the principles of the present disclosure. Moreover, in the drawings, like reference numerals designate corresponding parts throughout the several views. While exemplary embodiments are disclosed in connection with the drawings, there is no intent to limit the present disclosure to the embodiment or embodiments disclosed herein. On the contrary the intent is to cover all alternatives, modifications and equivalents.

FIG. 1a is a front view of a panel of a water retention/detention assembly according to one embodiment of the present disclosure;

FIG. 1b is a front view of a panel of a water retention/detention assembly according to one embodiment of the present disclosure;

FIG. 1c is a front view of a panel of a water retention/detention assembly according to one embodiment of the present disclosure;

FIG. 1d is a side view of a panel of a water retention/detention assembly according to one embodiment of the present disclosure;

FIG. 1e is a front view of a panel of a water retention/detention assembly according to one embodiment of the present disclosure;

FIGS. 1f-1h are perspective views of the panel of FIG. 1c including modular inserts according to various exemplary embodiments of the present disclosure;

FIG. 2 depicts six panels of the embodiment of FIG. 1c combined to form a water retention assembly according to one embodiment of the present disclosure;

FIGS. 3a-3c depict multiple panel water retention/detention assemblies constructed from the panel of FIG. 1c according to one embodiment of the present disclosure;

FIG. 4 is a perspective view of a panel of a water retention/detention assembly according to one embodiment of the present disclosure;

FIGS. 5a and 5b depict water retention/detention structures including a plurality of water retention/detention assemblies constructed from the panels of FIG. 1c according to one embodiment of the present disclosure;

FIG. 6 is a front view of a panel of a water retention/detention assembly according to one embodiment of the present disclosure;

FIG. 7 is a partial exploded view of a water retention/detention structure including support posts according to one embodiment of the present disclosure;

FIGS. 8a-8c are a partial exploded views of a water retention/detention structure including support members according to one embodiment of the present disclosure;

FIG. 9a is a cutaway view of a retention/detention assembly depicting a discharge device according to one embodiment of the present disclosure;

FIG. 9b is an exploded view of a filter device for a retention/detention assembly according to one embodiment of the present disclosure;

FIG. 10 depicts a retention/detention assembly including an inlet device and a discharge device with a trap according to one embodiment of the present disclosure; and

FIG. 11a depicts one embodiment of a retention/detention assembly of the present disclosure incorporating exemplary accessories that can be incorporated into the assembly;

FIG. 11b depicts exemplary accessories for the assembly of FIG. 11a; and

FIGS. 12a and 12b depict one embodiment of a storm water or grey water retention/detention assembly structure of the present disclosure.

### DETAILED DESCRIPTION

Disclosed herein are various embodiments of water retention/detention systems. Reference will now be made in detail to the description of the embodiments as illustrated in the figures, wherein like reference numbers indicate like parts throughout the several views. While several embodiments are described in connection with these figures, there is no intent to limit the present disclosure to the embodiment or embodiments disclosed herein. On the contrary, the intent is to cover all alternatives, modifications, and equivalents.

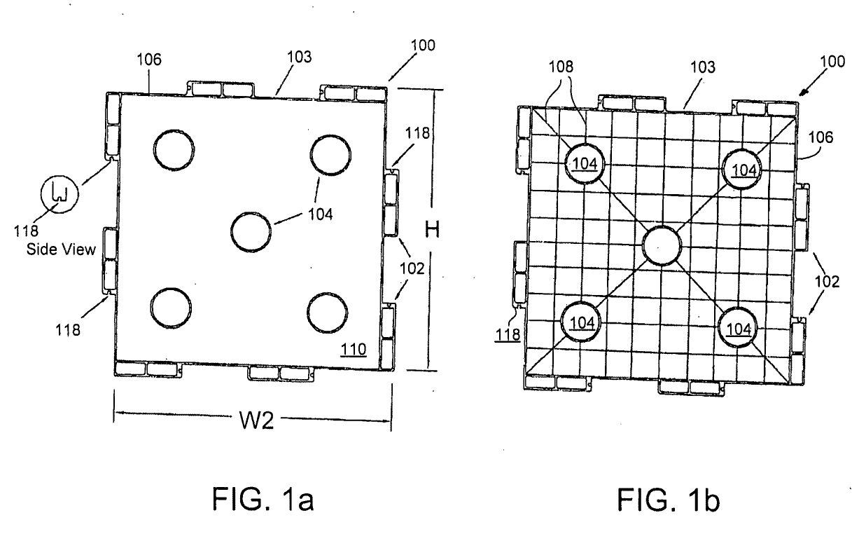

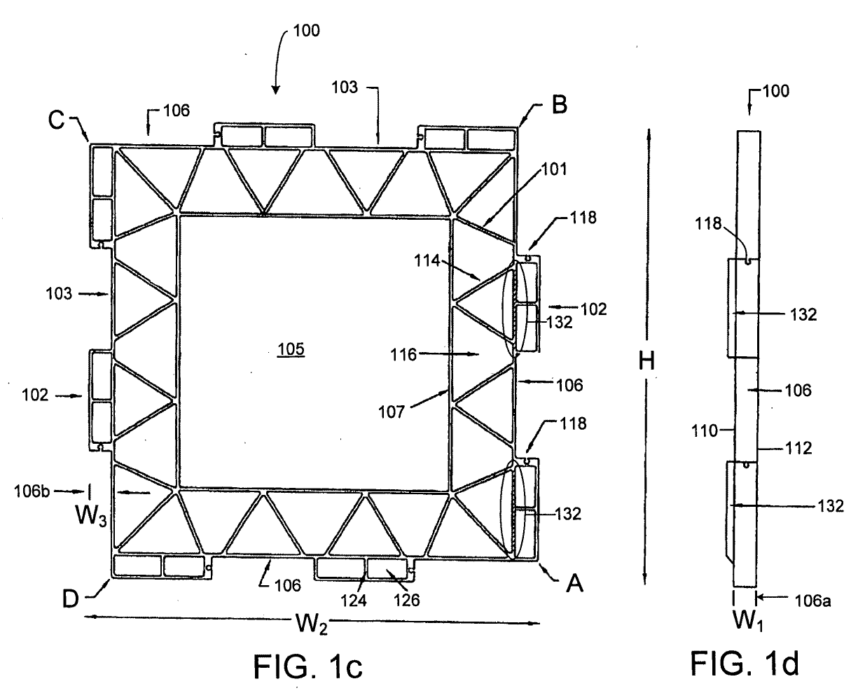

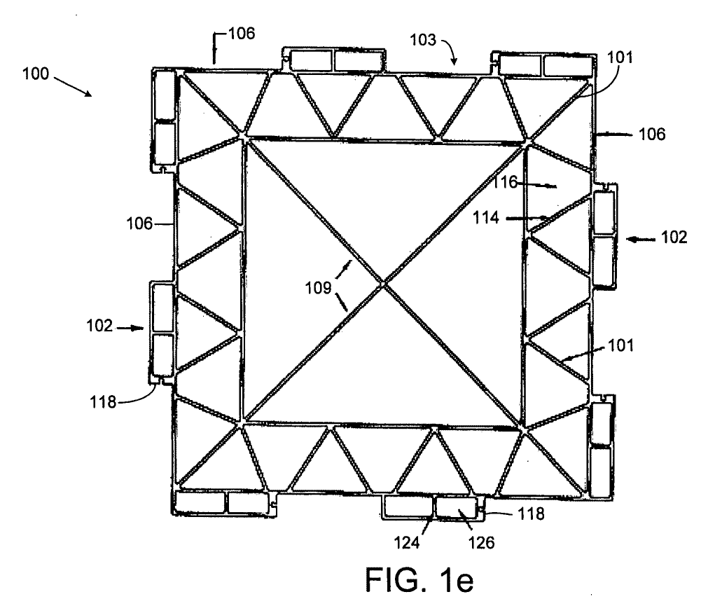

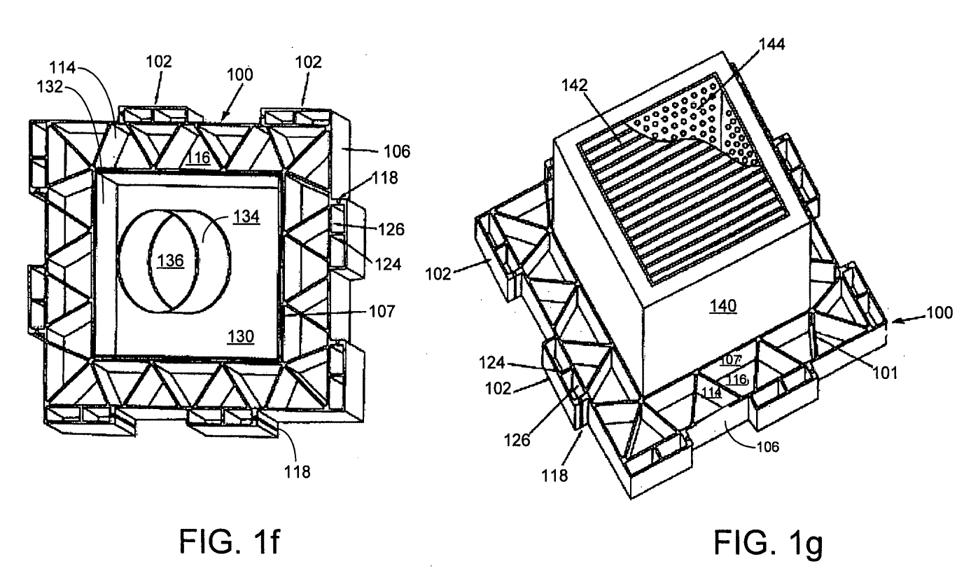

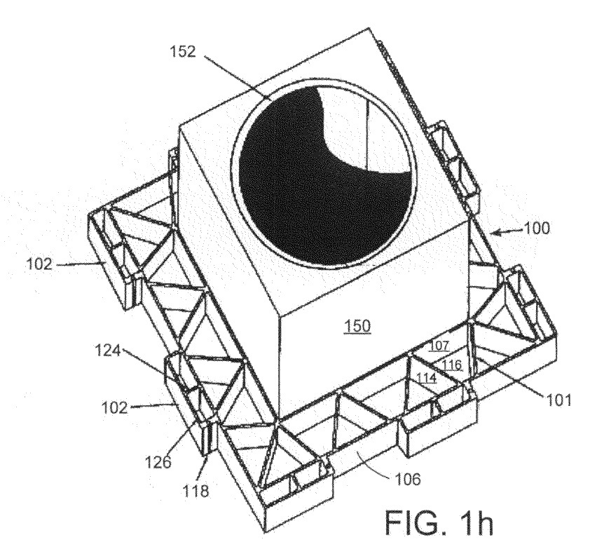

In this regard, reference is made to FIGS. 1a through 1h in which multiple views of multiple exemplary embodiments of a panel for the water retention/detention assembly and structure of the present disclosure and a side view of an exemplary panel are depicted. In the depicted embodiments, a panel 100 includes two opposed and substantially parallel surfaces, namely a first surface 110 and a second surface 112, outer sides or edges 106, tabs 102, and apertures or holes 104. Surfaces 110 and 112 are separated by a defined thickness, W1 (see FIG. 1d). The thickness of the panel may be determined to provide sufficient rigidity and strength for a given application. In one embodiment herein, surfaces 110 and 112 are planar.

Outer edges 106 define the outer peripheral sides of a panel 100. In the embodiments of FIG. 1a through 1h the edges 106 are substantially perpendicular to surfaces 110 and 112. In other embodiments, the edges may be angled or beveled. One or more tabs 102 may extend laterally outward from edges 106, as illustrated. Each of the four edges 106 of the panel have substantially identical arrangements or configurations of tabs extending from edges 106 and along their peripheral sides such that, when a panel is rotated 90, 180 or 270 degrees, the location of the edges and tabs are in substantially identical arrangements and spacing. Edge 106 from point A to Point B is substantially identical to edge 106 from Point B to Point C and so on.

The number of tabs 102 may vary so long as all four edges 106 are changed accordingly. In one embodiment, at least two tabs 102 may be formed along each outer edge 106, the tabs being spaced apart from each other along the outer edge 106 thus forming a recess or recesses 103 between the tabs 102. The location and spacing of the tabs allowing the tabs of the outer edge of a first panel to communicate with the corresponding recess or recesses formed between the tabs of a second panel. In another embodiment, one tab may be formed along each outer edge and a corresponding recess formed in the outer edge 106 of another panel along the edge in a location allowing the tab of the edge of a first panel to communicate and mate with the recess formed in an outer edge of a second panel.

Additionally, in the embodiment depicted in FIG. 1a the panels have a height, H, and a width, W2, where the height is the substantially the same as the width (H=W2) such that the panels are substantially square is shape. In other embodiments, however, the height H and the width W2 may be different, as for example in a rectangularly shaped panel.

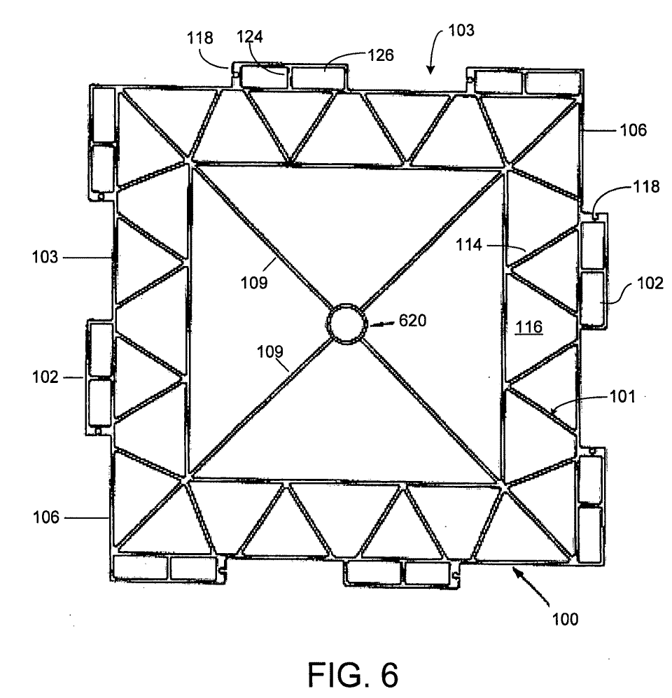

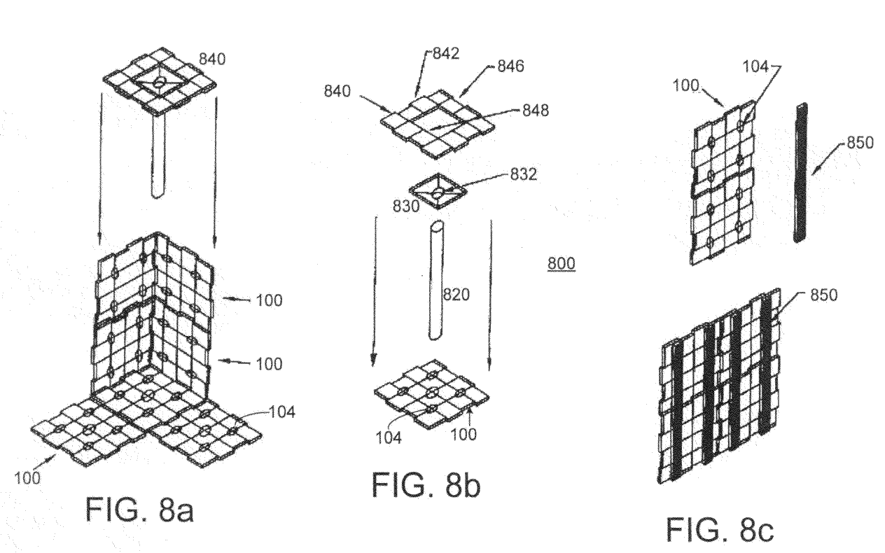

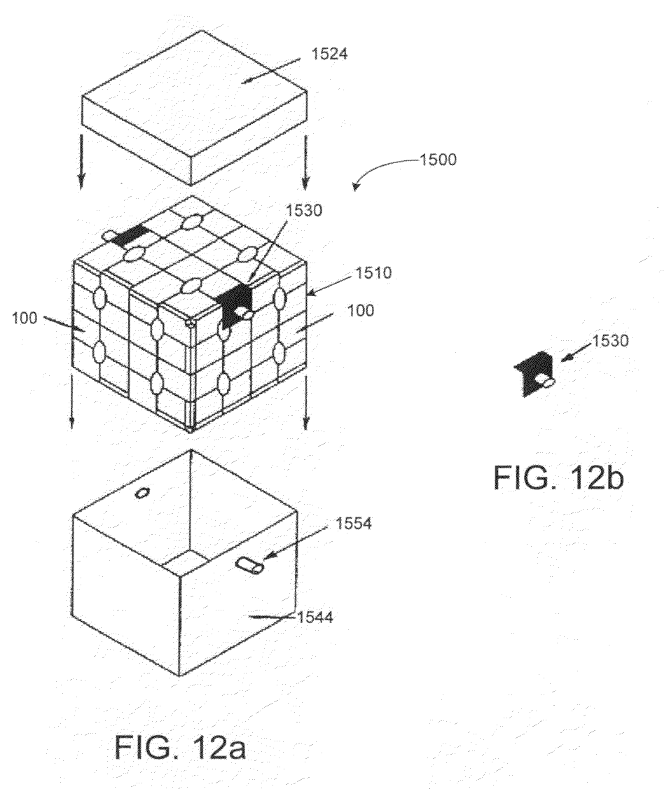

Apertures are located in surfaces 110 and 112 such that an aperture in surface 110 is aligned with an aperture on surface 112 and creates a hole 104 though the panel 100. FIG. 1a illustrates five such holes. Panel 100, however, need not have specifically five holes 104. There may be one or multiple holes in the panel. For example, FIG. 8c below illustrates four such holes and FIGS. 6 and 12a illustrate one hole. Further, the holes may be, but not need be, arranged such that when a panel is rotated 90, 180 or 270 degrees, the holes are in substantially identical arrangements. Although holes 104 are depicted as angular they may be any shape, including but not limited to, circles, oval, squares and other polygons. Additionally, the holes may be knockout holes, where the panel is manufactured with material filling the holes such that the material may be easily removed from the panel after manufacture to create a hole. Although depicted as passing through a tab or panel, the holes 104 may also be blind holes, where they do not pass completely through the panel.

Referring now to FIG. 1b, a panel for a water retention/detention assembly according to one embodiment of the present disclosure is illustrated. The panel 100 of FIG. 1b is similar to that of FIG. 1a, but further including ribs 108. The embodiment of a ribbed panel 100 depicted in FIG. 1b may have apertures 104, tabs 102, and outer edges 106 as in the panel of FIG. 1a. In the depicted embodiment, the ribs 108 may provide thickness, strength and rigidity to panel 100 while the removal of material in the area between ribs may reduce the weight of the panel as compared to a more solid panel (e.g., the panel of the embodiment depicted in FIG. 1a). It should be understood that arrangement of ribs as shown in FIG. 1b illustrates one embodiment of a ribbed panel and the depicted arrangement is not required. For example, the ribs 108 may be on one side 110, the opposite side 112, or both sides, of panel 100. Further, the ribs may be arranged or disposed differently than illustrated.

In another exemplary embodiment of a ribbed panel, the panel includes one or two opposed surfaces, for example planar surfaces, and a rib structure between the surfaces. In an additional embodiment of a ribbed panel with two opposed surfaces, the rib structure between the surfaces may form cells and the cells may be made in different shapes, including but not limited to, circles, ovals, hexagons and other polygons.

Referring now to FIG. 1c, a panel for a water retention/detention assembly according to one embodiment of the present disclosure is illustrated. The embodiment of a panel 100 depicted in FIG. 1c incorporates a truss like structure 101 along its outer four sides and set perpendicular to one another thus leaving a large opening 105 in the interior of the truss structure 101, the purpose of which provides access for providing maintenance and the like. The truss configuration also enhances structural forces. In an exemplary embodiment the truss structure can consist of a generally square frame having an outside edge member 106, an inside edge member 107 and beams 114 connecting the outside edge member 106 to the inside edge member 107. In this manner a truss structure is formed about the periphery of panel 100. In one embodiment the beams 114 are angled with respect to each other in a generally triangular layout having openings 116 therebetween. This truss design can provide additional load bearing strength where desired. In particular, one can design the truss frame depending upon size of load by varying the size of the truss frame, the number and thickness of its members, and the materials from which the frame is made. It can thus be made extra strong for heavy loads.

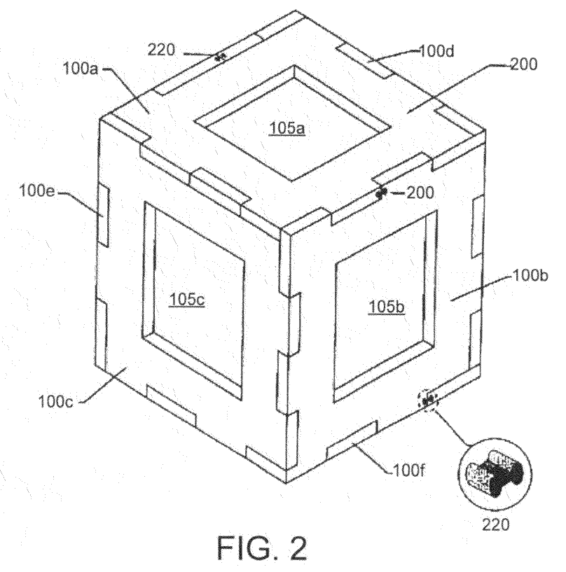

The panel includes tabs 102, similar to those of the panel of FIGS. 1a and 1b, extending laterally outwardly from edges 106, the extension of the tabs having a width W3. The tabs 102 of this embodiment, however, can also be formed with beams 124 forming openings 126 within the tabs. Further, the tabs 102 can include openings or slots 118 for receiving a fastener, such as fastener 220 depicted in FIG. 2, for fastening one panel to another panel.

Panel 100 of FIG. 1c can, optionally, include one or more openings 105 in the interior of the panel. As illustrated in FIG. 1c, the opening 105 can consist of a single large opening, allowing access to the interior of a water retention/detention structure formed of panels 100 of the type as illustrated, for example, in FIG. 2. Such an opening can allow cleanout of silt, debris or other trash that may accumulate within such a structure. As illustrated in connection with FIGS. 1a and 1b, for example, panel 100 of FIG. 1c may, instead of a single large opening, have a plurality of openings interior of the truss structure 101, or no opening at all.

In the embodiment in FIG. 1e, the internal portion differs from the internal portion of the embodiment in FIG. 1c, but the truss structure 101 and tabs 102 are unchanged, and the embodiments are interchangeable. The internal portion of panel 100 of FIG. 1e is solid having ribs 109 and no openings. Now referring to FIGS. 1c and 1d one or more optional shelves 132 are depicted extending along the top of edge 106 at the location of the attachment of one or more tabs 102 to edge 106 of a panel 100 of any of the embodiments herein. When assembled, shelf 132 of one panel supports shelf 132 of an adjoining panel adding structural stability and conveying load transfer from the truss frame of the one panel to the truss frame of the adjoining panel. The one or more shelves 132 can be applied to any of the embodiments of panel 100 described herein. Shelves 132 need not be located at the location of tabs 102. Instead, one or more shelves 132 may be located anywhere along the top of edges 106 along side 110, as desired.

In one embodiment, the panel 100 of FIG. 1c having a truss structure 101 may be designed to allow for one of a variety of modular inserts or accessories to be positioned into the opening 105 and secured to the panel. The design of a suitable modular insert can vary. Further, the modular inserts may be designed to be interchangeable one for another. For example, FIG. 1f depicts one embodiment of a modular insert 130 having sides 132 configured to fit within opening 105 adjacent inside edge 107 of panel 100 of FIG. 1c. The modular insert 130 includes a water inlet 134 having an inlet opening 136. In one embodiment the water inlet 134 and opening 136 can be designed to receive and be connected to a storm water pipe.

In other embodiments, for example as depicted in FIGS. 1g and 1h, panel 100 can comprise a truss structure 101 and tabs 102 such as illustrated in the FIG. 1c but including alternative modular inserts or accessories. For example, as depicted in FIG. 1g the modular insert can comprise a drainage inlet 140 having, for example, grates 142. A bucket or other trap device 144 can be positioned as an insert within the drainage inlet 140 to serve as a trap for debris that may pass through the grated inlet. Further, one or more filters, such as described in more detail below, may optionally be incorporated within the drainage inlet 140 as the trap device 144. FIG. 1h depicts another embodiment of a modular insert for panel 100 of FIG. 1c in the form of an access cover 150 including a manhole cover 152. An access chamber may be included with the access cover 150.

Panels 100 may be made of many materials or combinations of materials, including but not limited to, steel, iron, aluminum, polyethylene, polypropylene, polystyrene, other metals and metal alloys, plastic, wood, foam, rubber, concrete, cement and resin reinforced composites.

Referring now to FIG. 2, an embodiment of a water retention/detention assembly is illustrated having six panels, which are combined to form, for example, a cube shaped structure. Panels 100a-f form the six sides of the water retention/detention assembly 200. The tab or tabs 102 of a first panel, for example panel 100a, communicate with the recess or recesses 103 along edges 106 of an adjacent second panel, for example panel 100d. The communication of tabs and recesses between adjacent panels facilitates the alignment of the panels to form the water retention/detention assembly 200. Additionally, the communication between panels may couple or fasten the panels together. In some embodiments, fasteners may be used to couple the panels together. The fasteners may include, but are not limited to, screws, bolts, nuts, staples and rivets. In other embodiments no fasteners are used.

Although the tabs in FIG. 2 are depicted as having a width, W3, similar to the width between tabs of an adjacent panel, in other embodiments one ore more of the tabs can have a width less than the width between tabs of an adjacent panel. In still other embodiments more or less than two tabs may be located on a side of a panel.

In another embodiment, a fastener 220, such as a barbell shaped fastener, may be used to couple the panels together. The fastener 220 can have a narrow center and wider ends. The narrow center can fit into narrow openings or slots 118 in tabs 102 while the wider ends fit into wider portions of slots in tabs. In this way the narrow portion of the openings or slots 118 can provide a restriction that may not allow the wider ends of the fastener to pull through, thus coupling the panels 200 together, for example panel 100a to panel 100b as illustrated. The wider ends may be angular, rectangular or other geometric shapes.

In the embodiment depicted in FIG. 2, panel 100a forms the top of the assembly 200, panel 100f forms the bottom of the assembly 200 and panels 100b, 100c, 100d and 100e form the four sides of the assembly 200. Thus, the panels are arranged in a manner such that the assembly has a hollow interior, and each panel is positioned such that it has another panel opposite to it across the hollow interior. It should be understood that the six panels in FIG. 2 are substantially identical and have been given different labels to facilitate description of one embodiment of the present disclosure and not to indicate that the panels have substantial differences or that there specific arrangement is required. Further, for example, panel 100a does not need to be the top panel, it could be any one of the side panels or a bottom panel, while panels 100b-e may also be top or bottom panels. Likewise, panel 100f may form the top or sides of the assembly 200. Additionally, because the panels are substantially identical, the assembly, when rotated 90, 180 or 270 degrees, will be in a substantially identical arrangement. Therefore, once formed, the assembly may be placed or arranged without regard to orientation or location of any particular side or panel. Furthermore, though the panels depicted in FIG. 2 are stylized views of the panels of FIG. 1c having a peripheral truss structure, it should be understood that any of the embodiments of panel 100 described herein may be used in forming assembly 200.

By substantially identical it is meant that the panels 100 have substantially identical peripheral or outer edges 106 and a substantially identical arrangement of tabs 102 extending laterally from the edges and along the edges. In a preferred embodiment, each of the panels 100 has a height, H, and a width, W2, where the height is substantially the same as the width.

In other embodiments multiple assemblies may be assembled as depicted in

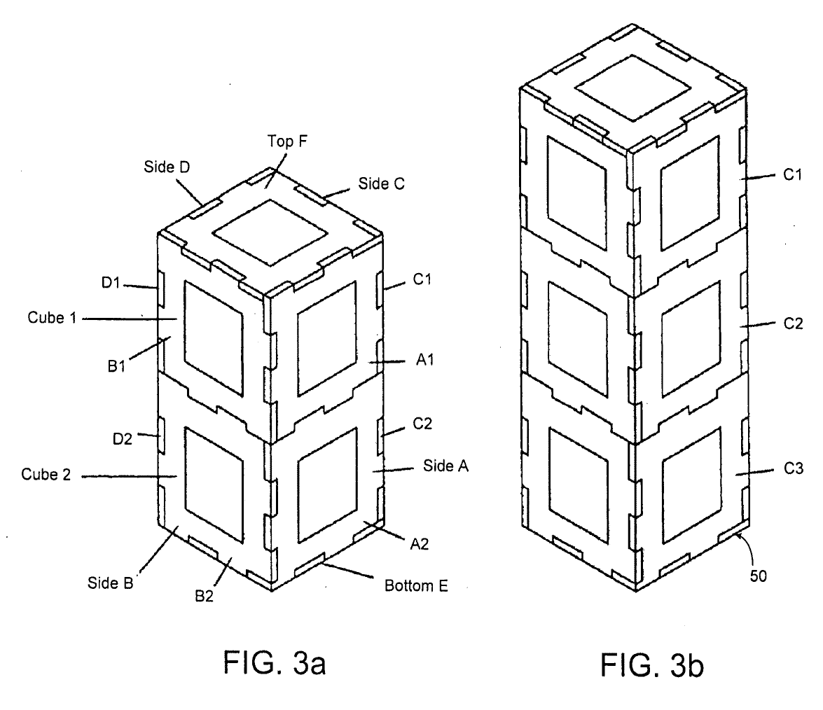

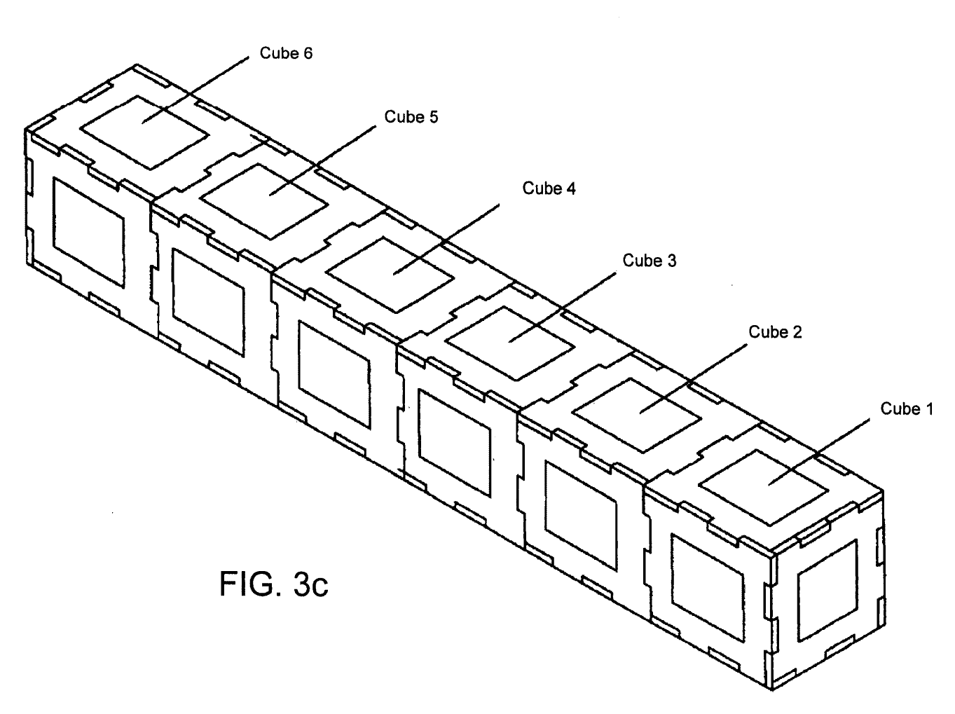

FIGS. 3a-3c. By assembling 10 substantially identical panels 100, a double cube formed of cube 1, C1, and cube 2, C2 can be formed as depicted in FIG. 3a. Bottom E and top F are joined with side A, Side B, Side C, and Side D. Side A consists of part A1 and A2. Side B consists of part B1 and B2. Side C consists of part C1 and C2 and Side D consists of part D1 and D2. Assembled cube 1 has no bottom and assembled cube 2 has no top as each side is assembled in a vertical manner. In the embodiment shown in FIG. 3b, a triple cube 50 comprised of cubes C1, C2 and C3 may be formed with 14 parts substantially like parts. Similarly, a quadruple cube can be formed with 18 substantially like parts, and the like. In yet another embodiment as shown in FIG. 3c, cubes may be assembled in a like manner to form a horizontal configuration for installation in a continuous trench like application. Thus, it can be seen that a outer retention/detention assembly of the present disclosure can be formed of six or more panels of the type disclosed herein.

In some embodiments the six panels forming one cube, 10 panels forming a double cube, and 14 panels forming a triple cube, may be made of the same material or they may be made of different materials. In still other embodiments the materials of one assembly may differ from or be the same as the material of another assembly. In still other embodiments, differing panels, such as panels of FIGS. 1a, 1b, 1c and 1e can be mixed and matched to form an assembly such as assembly 200 of FIG. 2, so long as they are substantially identical in the manner described above.

In yet another embodiment, the assembly of FIG. 3a can be formed from six panels, where for example parts A1 and A2 of side A can be formed as a single, unitary panel. Similarly, parts B1 and B2 of side B, etc. can be formed as a single, unitary panel. The panels for sides A-D, as depicted, would then be substantially rectangular in shape. The side panels A-D, however, would still be substantially identical to each other and to top panels E, F in that the panels would have substantially identical peripheral or outer sides 106 having a substantially identical spacing of tabs 102, along the sides.

In other embodiments, the assembly may be at least partially wrapped in material, as depicted in FIG. 6 discussed in more detail below. By wrapping the assembly in material structural support may be added, the probability of matter entering or leaving the assembly may be reduced and the rate at which water flows into or out of the assembly may be controlled. The wrapping material may be made of many materials and structures, including but not limited to, geosynthetics, geotextiles, geogrids, geomembranes, polypropylene, polyester, metals and metal alloys, rubber and plastics.

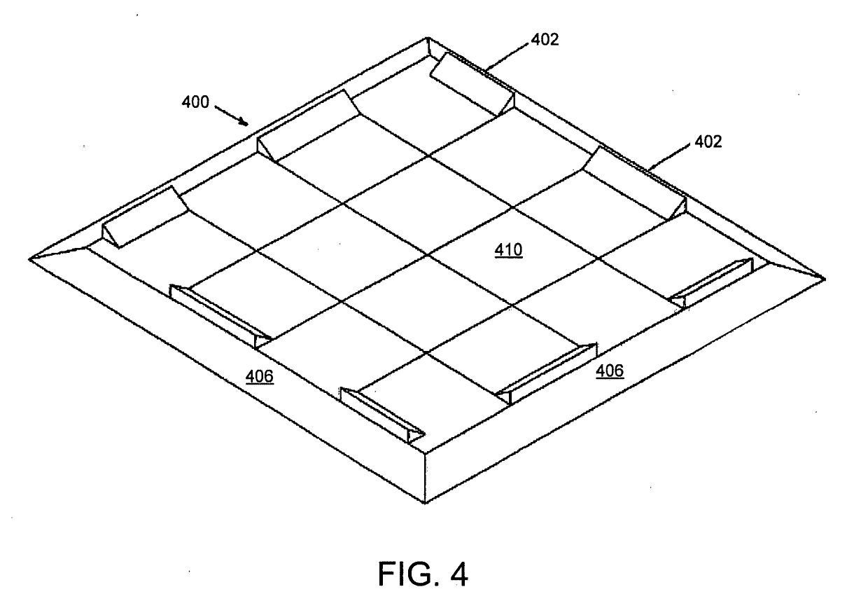

Referring now to FIG. 4 showing yet another embodiment of a ribbed panel 400 where shelves 402 can be located on an inside surface and edges 406 are not perpendicular to an inside surface 410 or an outside surface. Six substantially identical panels 400 may be assembled with inside surfaces 410 facing each other to form an assembly. In such an embodiment, outer edges 406 are inclined or beveled at approximately a 45 degree angle with the outside surface. When assembled into an assembly the edges 406 of adjacent panels 400 may contact each other over at least a portion of their surface. The surface area provided by inclined edges 406 may provide an improved mating surface than an assembly without such inclined or beveled edges. Additionally, when six panels are assembled into an assembly, the shelves 402 extend from the inside surface 410 of a panel and communicate with similar shelves extending from an adjacent panel and may also align one panel with adjacent panels of an assembly. When shelves (e.g., tabs 402) extend from an inside surface they may also act as load bearing shelves such that when several panels are formed into an assembly the shelves on side panels may bear some of the load of a top panel.

In another embodiment, the panels 400 may include, for example, a combination of tabs 102 as shown in FIGS. 1a-1d and inclined surfaces as shown in FIG. 4. For example, inclined or beveled surfaces 406 may be provided at only the corners of the panels. Six substantially identical panels may be assembled with inside surfaces facing each other to form an assembly. In such an embodiment tabs 102 of one panel may communicate with or engage tabs of an adjacent panel. Additionally, the inclined surfaces 406 extend from the edges of the panels and provide a mating surface at corners between adjacent panels. Further, panel 400 may be made of the same type of materials as panels 100 described above.

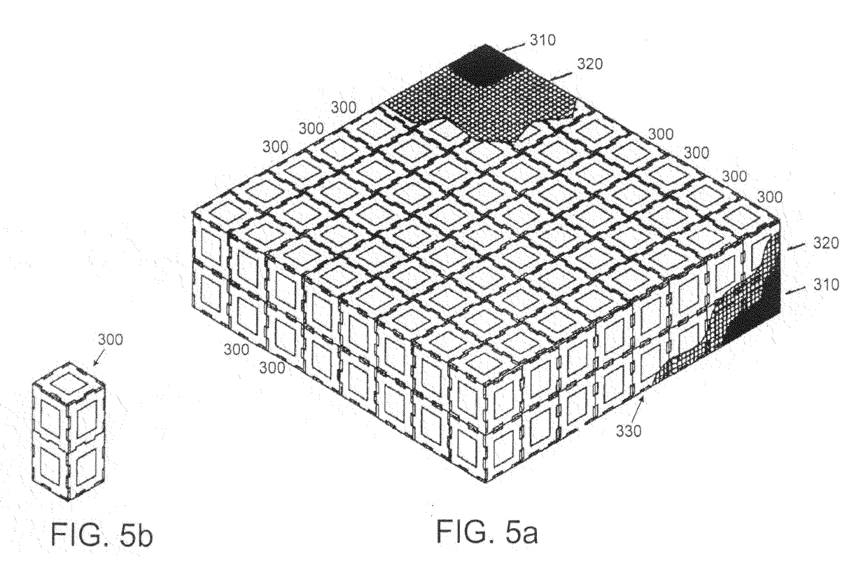

Referring now to FIG. 5, a depiction of one embodiment of a water retention/detention structure 330 is illustrated and represents a composite assembly of double cube structures. The double cube structures in FIG. 5a can take, for example, the form of the double cube embodiment of FIG. 3a, described above. Although the structure 330 of FIG. 5a depicts sixty-four double cube assemblies 300 substantially aligned and placed next to each other, other arrangements are possible. Other embodiments may include assemblies placed in a staggered arrangement where the side of one assembly is near the sides of two or more other assemblies. In other embodiments the structure 330 may comprise more or less than sixty four assemblies 300. Additionally, although depicted as sitting next to each other, the assemblies may also be coupled or fastened together. In other embodiments, assembly 330 in FIG. 5a may be substituted by a single cube assembly 200 as shown in FIG. 2 or a triple cube assembly 50 as shown in FIG. 3b.

The water retention/detention structure 330 may be fully wrapped or at least partially wrapped with geo-grid 320 and/or geotextile 310 material, such as that described above. By wrapping the structure in geo-grid material 320 structural support may be added, the probability of matter entering or leaving the assembly may be reduced, and the rate at which water flows into or out of the assembly my be controlled. The wrapping of the geo-grid material 320 adds structural integrity and presents support for soil backfill and compaction on the top of and along the four sides of the water retention/detention structure 330 as shown in FIG. 5a. The geo-grid 320 material may be made of many materials and structures such as those described previously. A suitable example of a geo-grid material is typically a synthetic material (for example, polyester) characterized by woven bands or yarns of narrow elements in a regular, grid-like pattern with large voids between the woven bands. The tensile strength of the woven bands and the voids between those bands lend stabilizing strength to the projects they are used in. An example of suitable geo-grid materials are those manufactured by Strata Systems, Inc of Cumming, Ga. Following the placement of geo-grid 320 as shown in FIG. 6, a layer of geotextile 310 may be placed over the geo-grid 320 in a similar manner. A geotextile material is a synthetic permeable textile material and can be woven or non-woven in form. A suitable example of a geotextile material is PermaFab 40 manufactured by JDR Enterprises, Inc. of Alpharetta, Ga. The geotextile 310 acts as a soil barrier and allows for the passage of water into or out of the water retention/detention device.

In other embodiments, rectangular shapes may be formed from the panels. In one such embodiment the walls of the structure may be assembled with the tabs of one panel communicating with tabs of another panel such that the panels are in substantially the same planar alignment, forming a planar structure, such as illustrated in FIG. 3a above. In this embodiment, each side wall may include two panels and the resulting structure may be rectangular in shape. It should be understood that by assembling panels into larger planar structures large water retention/detention structures may be formed, for example a long structure may be formed for use in a trench as shown in FIG. 3c.

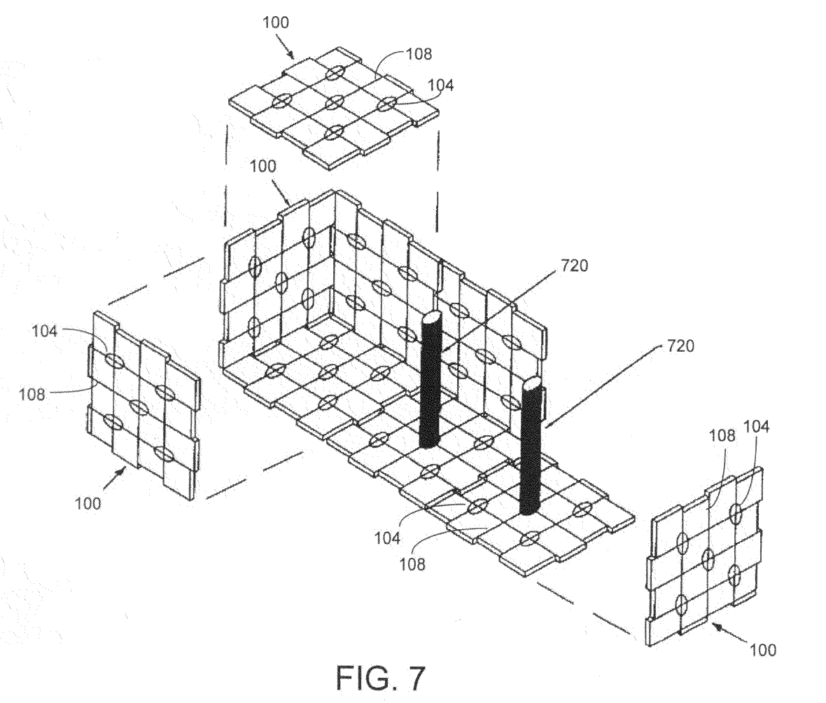

Referring now to FIG. 6, one embodiment of panels 100 is depicted that may also include reinforcement aperture or hole 620 substantially located in the center of the panel or may contain multiple holes, similar to hole 620, placed, for example, in a uniform pattern. While FIG. 6 depicts, for example, panel 100 of FIG. 1e having a hole 620, any panel of the present disclosure may be used, however, including panel 100 of FIG. 1a having five holes 104. When six panels are assembled into a water retention/detention assembly, a hole 620 of one panel may be in communication with a hole 620 of an opposite panel allowing for, among other things, a reinforcement member (such as illustrated in FIGS. 7 and 8b below) to be inserted internally to add structural integrity to the assembled cube. In one embodiment the reinforcement member is a bar inserted into the holes. In another embodiment a hollow pipe filled with cement or concrete can be inserted into hole 620 and used to reinforce the cube. The reinforcement member(s) can be in either a vertical or horizontal application. While holes 620 are depicted as round they may be of any shape, including by not limited to, circles, oval, squares and other polygons. Additionally, although depicted as passing through a tab or panel, the holes my also be blind holes, where they do not pass completely though the tab. A reinforcement member may be made of many materials or combinations of materials, including but not limited to, steel, iron, aluminum, other metals and metal alloys, plastic, wood, foam, rubber, concrete, cement and resin reinforced composites.

Referring now to FIG. 7, one embodiment of a water retention/detention structure with reinforcement or support members 720 is depicted in a partial exploded view. In the depicted embodiment, structure 700 is comprised of multiple panels 100 and support members 720. A support member 720 may have a bottom end in communication with a bottom panel and a top end in communication with a top panel. In this way additional support may be provided to the top panel. It should be understood that although support members 720 are depicted in a vertical arrangement, a support member may be orientated in other directions, for example in a horizontal direction which may provide additional support for the side panels. Further, although support members 720 are depicted as centrally located with respect to panels 100 they need not be and may be positioned off-center and in multiple locations in relation to one or more of the holes 104 of panels 100. In one embodiment, each end of a reinforcement or support members 720 is associated with an aperture or hole 104 in the panels. While FIG. 7 depicts, in particular panel 100 of the type illustrated in FIG. 1b, any panel of the present disclosure may be used having one or more apertures or holes 104, 520 for receiving reinforcement or support member 720. Reinforcement or support member(s) 720 may be made of many materials, including but not limited to steel, iron, aluminum, other metals and metal alloys, plastic, wood, foam, rubber, concrete, cement and resin reinforced composites. Although depicted as round in cross-section, in other embodiments the support member shape may have another cross-sectional shape and may include, but not limited to, a hollow member to be filled with concrete or other material, beams, such as I or H beams, or preformed concrete.

Referring now to FIGS. 8a, 8b, and 8c, one embodiment of a water retention and detention structure with supports is depicted in a partial exploded view, respectively. In the embodiment depicted in FIGS. 8a and 8b, the structure 800 is comprised of multiple panels 100, a support member 820, a hopper 830, and a support panel 840. Again, while panel 100 of the type of FIG. 1b is depicted, any panel 100 of the present disclosure is suitable. The support panel 840 has similar tabs 842 and edges 846 as the other panels 100, but may be manufactured such that the panel 840 contains an internal support aperture 848 which may communicate with, for example, hopper 830 with an aperture 832. The aperture 832 may communicate with a support member 820.

When assembled as depicted in the embodiment of FIG. 8a, a lower end of a support member 820 communicates with a lower panel and an upper end of the support member 820 communicates with the hopper 830. The hopper 830 may then communicate with the aperture 848 of panel 840. In this way support member 820 and hopper 830 may provide support to panel 840. The hopper 830 may also distribute support nearer the edges of panel 840 than in other embodiments which do not include a hopper, for example the embodiment of FIG. 7. In other embodiments support member 820 and the hopper 832 may be hollow forms and may be filled with concrete or other support material, which, once cured, provides support to panel 840. In such an embodiment the hopper 832 may also funnel the support material into the support member 820. In another embodiment the support member 820 and hopper 830 may be prefabricated support members which may be assembled onsite, for example, preformed concrete structures.

Although FIG. 8a depicts a structure two panels 100 high and with one support member 820 and hopper 830 it should be understood that the structure may be more or less than two panels 100 in height and may comprise more than one support member 820 and hopper 830, such that a large structure is formed and the supports also provide accessibility to the inside of the assembly. The support member 820 and hopper 830 may be made of many materials, including but not limited to those listed above. Additionally, support member 820 may be made into different shapes including, but not limited to, those described above with respect to FIG. 7.

Support members may also be placed along the side or sides of panels 100 as depicted in FIG. 8c. Support member 850 includes attachment members that may communicate, for example, with apertures or holes 104 such that support member 850 may be coupled to panels 100. Additionally, multiple panels 300 may be combined to form a planar structure and multiple supports members 850 may be coupled to the planar structure. In other embodiments, support members 850 may be coupled to panels 100 with fasteners. The support members 850 may be fastened to panels 100 using many different fasteners including but not limited to, nuts, bolts, screws and nails. In still other embodiments, the support members may be hollow and may be filled with structural material, such as concrete, to provide additional structural support and may also be made into different shapes including, but not limited to, those described above with respect to FIG. 7.

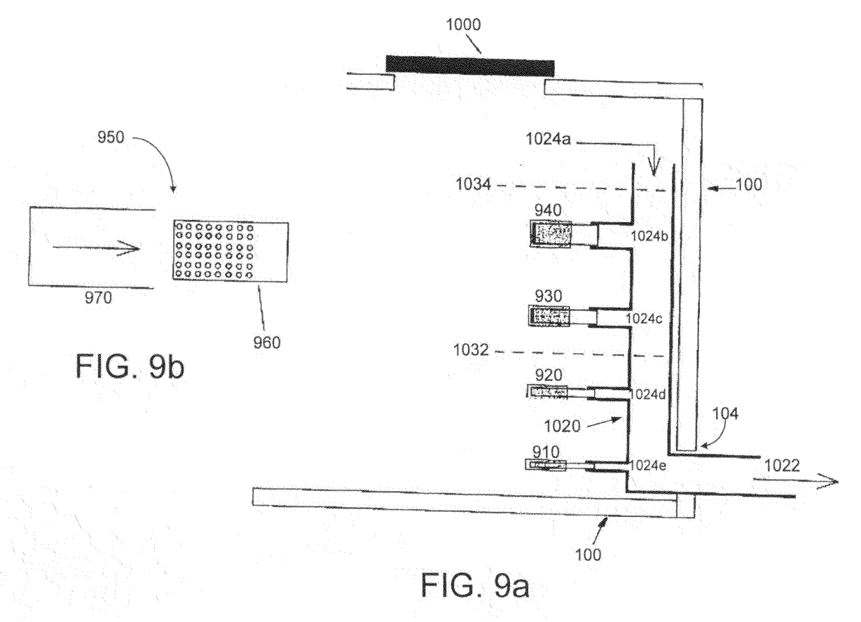

Referring now to FIG. 9a and FIG. 9b, a cutaway view of one embodiment of a retention/detention assembly, such as assembly 330 of FIG. 5 (though any other assembly of the present disclosure can be employed, such as assembly 200 of FIG. 2 or the assemblies of FIGS. 3a-3c), including a discharge device 1020 and, for example, an optional manhole cover 1000 is depicted. Discharge device 1020 may be located inside a retention/detention assembly or structure with a plurality of discharge inlets (e.g., inlets 1024a-e) in communication with a discharge outlet 1022 located in an aperture or hole 104 which is located in a panel, for example panels 100, 400. The discharge inlets 1024a-e may be of varying sizes and located at varying heights in the discharge device 1020 such that different water levels in the structure or assembly may allow water to enter different inlets and allow for control of flow rate. For example discharge inlets 1024a-e have increasing diameters from bottom to top of discharge outlet 1020 that allow for greater flow rate as the water level in the assembly increases. In this way the discharge device may regulate discharge flow rate. By way of example, when the water level is at line 1032 water may enter discharge inlets 1024d and 1024e and flow out of discharge outlet 1022 and when the water level is at line 1034 water may enter discharge inlets 1024b-e and flow out of discharge outlet 1022. It should be noted that discharge 1024e is smaller than 1024d which is smaller than 1024c and so on.

Discharge inlets 1024b, 1024c, 1024d, and 1024e can be optionally fitted with dual filters 910, 920, 930, and 940 which are disposable and changed as a part of a scheduled maintenance procedure and are easily accessible through access panel 100. Filters 910, 920, 930, and 940 have a size corresponding to discharge inlets 1024e, 1024d, 1024c and 1024b. The filters are designated as round, but may also be square, rectangular, oval or other shapes. Referring now to FIG. 9b, an exemplary filter device is depicted in the form of a dual filtration and water purification device 950 with part 960 depicting a hollow structure made from materials mentioned previously, with an array of perforations to allow passageways for water to enter inlets 1024b, 1024c, 1024d, and 1024e shown in FIG. 9a. Part 960 of FIG. 9b can have an inner filling of a sponge like or membrane filter material for purification of the storm water which removes oils, gases, heavy metals and the like. Part 970 can be an external filter or screen which removes silt, trash and other foreign objects or material. The outer member or casing of part 960 may be screening material made of previously mentioned materials or a geotextile material, for example as described above. It should be understood that the filters need not be dual filtration and water purification devices and that other filter devices can be used as needed.

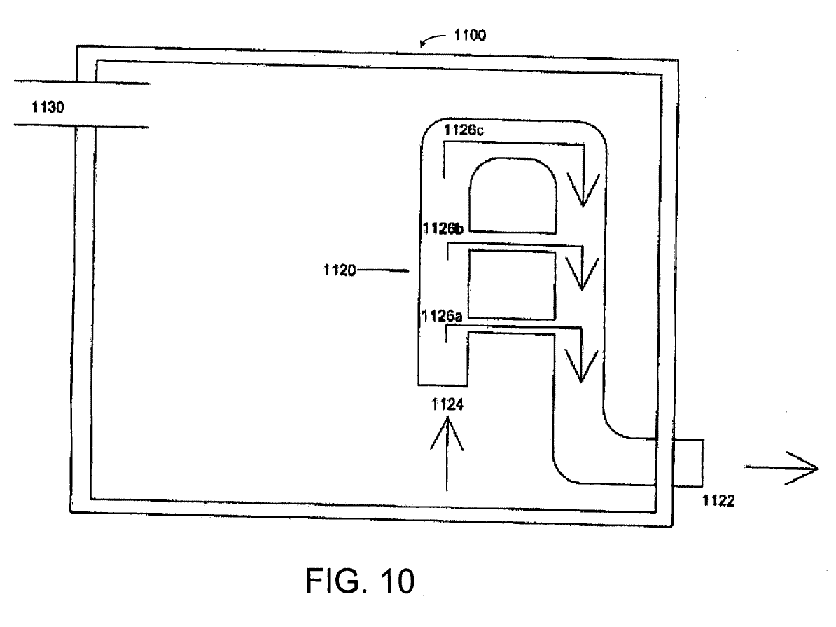

Referring now to FIG. 10, one embodiment of a water retention/detention assembly structure 1100 is depicted with an inlet device 1130 and a discharge device 1120. The structure 1100 may include an inlet 1130 that provides a communication path between the outside area and the inside of the structure 1100 such that water and other materials may enter the structure through the inlet 1130. The discharge device 1120 may have one or more discharge inlets 1124 shaped and located such that the discharge device 1120 creates a trap that may reduce the amount of debris or oil that is discharged from the assembly or structure 1100. The discharge device 1120 may further include multiple flow paths 1126a-c that may vary in size. For example, the flow paths 1136a-c may increase in size from bottom to top, such that as the retention/detention assembly fills the water flows through more paths with greater diameters. In this way the discharge device 1120 may regulate flow, such that as the water level increases, the discharge flow rate may also increase. Thus discharge device 1120 may regulate flow and may reduce the amount of debris and oil that is discharged from the retention/detention assembly. In other embodiments, such as a tank to hold water, the discharge device of FIG. 10 may have one flow path rather than multiple paths. In such an embodiment the discharge device can serve as a trap and may not regulate flow. Other embodiments of a discharge outlet of one retention or detention assembly may communicate with the inlet of another retention or detention assembly such that the discharge of one assembly my flow into another assembly. In still other embodiments, a retention or detention assembly may have one or more inlets, discharge devices and discharge outlets. Referring again to FIG. 10, discharge inlet 1124 may or may not have a disposable filter device as shown in FIGS. 9a and 9b.

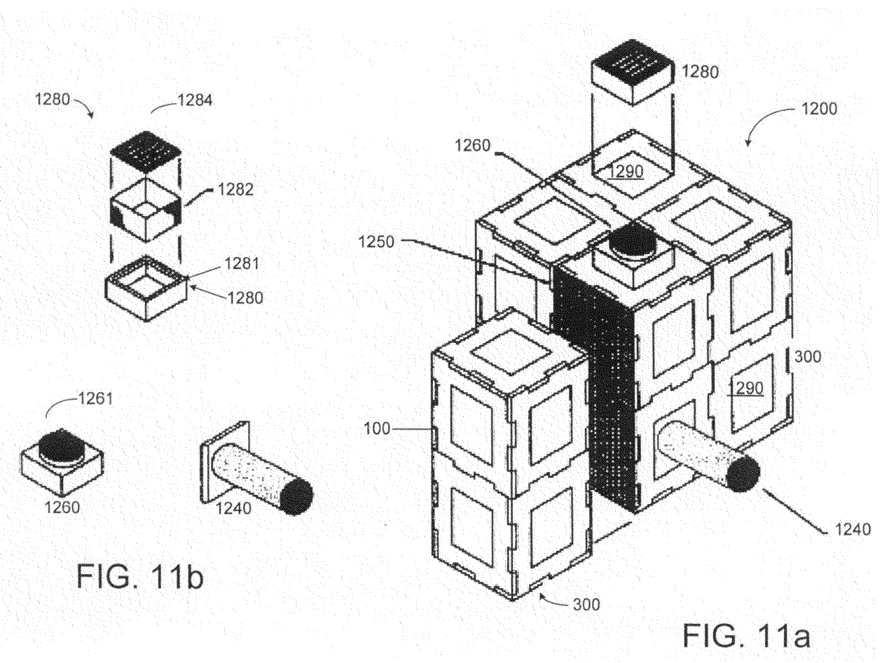

Referring now to FIG. 11a, one embodiment of a water retention/detention assembly device 1200 is depicted formed by placing, for example double cubes, such as double cubes 300 of FIG. 5b or FIG. 3a employing panels 100, for example panels 100 of FIG. 1c, adjacent to one another to form a larger composite retention/detention assembly device having a water inlet 1280, an access/inspection module 1260 as shown in detail in FIG. 11b and an isolation screen 1250. The isolation screen 1250 may encircle one double cube 300 or multiple cubes 300 to form a filtration area which retains trash and debris from exiting the retention/detention assembly for removal through access/inspection module 1260. Isolation screen 1250 can be made from materials previously mentioned, such as a geo-grid or geotextile material, and the screen sieve size may be predetermined and may vary for particle size retention. Isolation screen 1250 of FIG. 11a is not limited to the location as shown but may have other locations within or about the water retention/detention assembly.

Referring now to FIG. 11b, module 1260 is an access panel with a suitable manhole cover 1261 and can be fitted to any opening 1290 of the water retention/detention assembly. Module 1240 of FIG. 11b is an infill pipe as depicted in FIG. 11a and can be placed any opening 1290 in any of the side panels of the water retention/detention assembly. Additionally, module 1280 as shown in FIG. 11b is a grated module that can be placed in any opening 1290 with its application being water drainage from, for example, a parking lot or other ground surface area, into device 1200. Module 1280 of FIG. 11b has frame 1281 and an interior insert 1282 to the frame 1281 for the collection of trash and debris so as not to enter the retention/detention assembly. Insert 1282 can contain, for example, sponge like or filter membrane material to absorb gas, oil, and other chemical contaminants. Frame 1281 slotted openings or perforated openings. Insert 1282 can be positioned within a frame 1281 and be designed to be replaceable or interchangeable with other inserts. A grate cover 1284 may be placed over the frame 1281 and insert 1282.

It should be understood that though the water retention/detention assembly structure 1200 depicted in FIG. 11a is shown to be made of panels 100 of FIG. 1c discussed above, any of the panels 100, 400 of the present disclosure can be used to form the device. Further any one or more of the modular inserts, such as those described above in relation to, for example, FIGS. 1f-1h, can be used as well. Similarly, the cube subassemblies 300 are not limited to double cube subassemblies and can be formed of, for example, single cube assemblies, such as that depicted in FIG. 2, and triple or more cube assemblies, such as those depicted in FIGS. 3b and 3c. Likewise, the number of cube assemblies used to form device 1200 can vary depending upon, for example, the need and application for the device.

Devices for storm water or grey water retention can be constructed or assembled from the panels disclosed herein. Depicted in FIG. 12a is one embodiment of such a device 1500. The water retention device 1500 includes an assembly 1510 of panels 100, a liner 1544 and a top 1524. As illustrated, assembly 1510 is in the form of a cube comprised of multiple panels 100, though any other panel described herein can be used. The assembly 1510 can include an inflow and outflow device 1530 allowing for flow of water into and out of the assembly 1510 and the retention device 1500. The inflow and outflow device 1530 can take the form of, for example, a preformed adapter such as illustrated in FIG. 12b. Assembly 1510 need not take the shape of a cube and can be any other shape desired to fit the particular application. For example, retention device 1500 can be designed as an underground retention structure used for the storage of storm water or grey water. The water retained in retention device 1500 can later be used, for example, for irrigation.

Assembly 1510 is designed to be inserted into and fit within liner 1544. In one embodiment, the liner can be a preformed liner made of a water impermeable material. Liner 1544 can include a boot 1554 designed for receiving the inflow and outflow device 1530. Once the assembly 1510 is placed within the liner 1544 and the inflow and outflow device 1530 is inserted into the boot 1554, a top 1524 can be placed over the liner 1544 including the assembly 1510. In one embodiment, the top 1524 can be preformed and also made of a water impermeable material. Though in another embodiment, if desired, the top may be made of a water permeable material.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A system for retaining or detaining water or both, comprising:
six or more panels arranged adjacent to each other to form an assembly, the assembly having a hollow interior and in which each panel has an opposite panel across the hollow interior, each panel comprising;
a first surface;
four sides which define outer edges of each panel;
one or more tabs extending laterally from each of the outer edges of each panel in substantially identical spacing on each of the sides of each panel;
one or more recesses formed in substantially identical spacing on each of the sides of each panel, the one or more recesses corresponding in location along the sides of the panels to the one or more tabs; and
the one or more tabs of one outer edge of a first one of the panels communicating with the one or more recesses of one outer edge of a second one of the panels for combining the panels into the assembly.

2. The system of claim 1, wherein at least two tabs extend laterally from each of the outer edges of each panel, the tabs being spaced apart from each other along the outer edges forming a recess between the tabs.

3. The system of claim 1, wherein at least one of the panels further comprises a first planar surface and ribs extending from the first planar surface of said panel.

4. The system of claim 1, wherein at least one of the panels further comprises a first planar surface and an aperture in the first planar surface of said panel defining a hole in the first planar surface of said panel.

5. The system of claim 4, said panel further comprising a second planar surface substantially parallel to the first planar surface, wherein the second planar surface includes an aperture in communication with the aperture of the first planar surface such that a hole is formed through the panel.

6. The system of claim 1, wherein the assembly is at least partially wrapped with material.

7. The system of claim 1, further comprising an opening in a tab of a first panel of said panels and an opening in a tab of a second panel of said panels allowing said tab of the first panel to be coupled to said tab of the second panel by way of the openings in the respective tabs.

8. The system of claim 1, wherein said panels have substantially identical configurations along their peripheral sides.

9. The system of claim 8, wherein the peripheral sides of each of said panels are of a substantially similar length.

10. The system of claim 9, wherein said panels are substantially identical.

11. The system of claim 1, wherein at least one of said panels has a peripheral truss structure or has ribs on one of its planar surfaces or both.

12. The system of claim 1, wherein at least one of said panels includes a peripheral truss structure and has an opening formed through the panel interior of the truss structure.

13. The system of claim 12, wherein the at least one panel having a peripheral truss structure is designed to receive an insert within the interior opening.

14. The system of claim 13, wherein the insert can be a selected one of a number of interchangeable accessories.

15. The system of claim 1, wherein the one outer edge of one of the panels and the one outer edge of at least one other panel communicating with each other include at least one shelf on each of the communicating edges of said panels, the shelves being positioned along said outer edges such that when assembled the shelf of one outer edge of the first one of the panels communicates with and supports a shelf of one outer edge of the second one of the panels.

16. The system of claim 1, wherein each outer edge of each of the panels includes at least a portion of the outer edge that is a beveled edge.

17. The system of claim 1, wherein the system comprises six or more panels arranged adjacent each other to form a first assembly, six or more additional panels are arranged adjacent to each other to form a second assembly, and the first assembly and second assembly are positioned together to form a composite assembly comprised of both the first assembly and the second assembly.

18. The system of claim 17, wherein the composite assembly is at least partially wrapped with a material.

19. The system of claim 1, wherein one or more reinforcing members are positioned within the hollow interior of the assembly in communication with a surface of at least one panel and also in communication with a surface of an opposed panel.

20. The system of claim 1, further comprising a discharge device for control of the rate of flow of water out of the system, or a filter device for filtering water entering or exiting the system, or both.

21. The system of claim 17, wherein the composite assembly includes at least one panel having a peripheral truss structure and a central opening for receiving an insert, and the insert is selected from the group consisting of an access structure, a drainage inlet, and a discharge outlet.

22. The system of claim 21, wherein the composite system is at least partially wrapped.

23. The system of claim 1, further comprising a liner into which the assembly is placed and a top covering the liner and assembly.

24. The system of claim 23, wherein one or both of the liner and the top comprise a preformed structure and the liner and the top are formed of a water impermeable material.

25. An assembly for retaining or detaining water or both, comprising:
a plurality of structures forming the sides, top and bottom of the assembly;
the structures comprised of panels arranged adjacent to each other, the panels of said assembly being arranged in a manner such that said assembly has a hollow interior and each panel has a panel arranged opposite to it across the hollow interior of said assembly, each panel comprising;
a first surface;
four sides of substantially similar length which define the outer peripheral edges of each panel; and
one or more tabs having substantially identical spacing along each of four sides of each panel;
the tabs of at least one panel communicating with the tabs of at least one other panel for the alignment of the panels into the assembly.

26. The system of claim 10, further comprising one or more support members for supporting one panel of the assembly against an opposite panel of the assembly.
